(19) United States
(12) Patent Application Publication
(10) Pub. No.: US 2009/0215319 A1
(43) Pub. Date: Aug. 27, 2009

(54) Green Power Strip

(76) Inventor: Hanoz Gandhi, Marina Del Rey, CA (US)

Correspondence Address: Walter P. Opaska;Bryan Cave LLP, Suite 2200, Two North Central Avenue, Phoenix, AZ, 85004, US

(21) Appl. No.: 12/034,836

(22) Filed: Feb. 21, 2008

(51) Int. Cl. H01R 25/00

(52) U.S. Cl. 439/654

(57) ABSTRACT

There is disclosed an apparatus for a green power strip. The apparatus comprises a power strip comprising a plurality of outlets, and a wireless remote control comprising a remote control switch. A subset of the plurality of outlets on the power strip is selected and the remote control switch controls the selected subset of the plurality of outlets.

### RELATED APPLICATION INFORMATION

Priority Claim Under Rule 1.78(b): This patent claims priority from the following provisional patent applications:

Priority Claim Under Rule 1.78(d): This patent claims priority from the following non-provisional (i.e., regular) patent applications:

Disclosure under Rule 1.78(f)(1) (filing/priority date within two months, one common inventor, common owner): None.

Other related applications:

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to a power strip apparatus and method for controlling outlets on a power strip.

2. Description of the Related Art

Power strips are often set up to control a variety of devices, including computers, printers, scanners, HDTVs, DVD players and numerous other electronics, appliances, or any other equipment. Generally, power strips comprise one switch that controls all of the outlets on the power strip. That is, when the switch is turned on, all of the outlets on the strip are on. Similarly, when the switch is turned off, all of the outlets on the strip are off.

### DESCRIPTION OF THE DRAWINGS

FIG. 1 is an exemplary view of a green power strip.

FIG. 2 is a schematic diagram of the green power strip shown in FIG. 1.

FIG. 3 is an exemplary view of a green power strip.

FIG. 4 is a schematic diagram of the green power strip shown in FIG. 3.

### DETAILED DESCRIPTION

Throughout this description, the embodiments and examples shown should be considered as exemplars, rather than limitations on the apparatus and methods disclosed or claimed.

It has become increasingly common for people to need power strips because of all of the appliances and equipment in their homes. Examples of such appliances and equipment include televisions, DVD players, home theater systems, computers, printers, audio devices, cameras, video cameras, and other audio-visual equipment. Therefore, instead of plugging these appliances directly into an electrical outlet on the wall, many people use power strips, or other similar appliances, to plug all of these various appliances and equipment into. Because many appliances may be plugged into power strips or surge protectors, people may tend to forget to turn off certain appliances when they are not being used.

For example, imagine that a computer and printer are plugged into a power strip. A person may remember to turn the computer off after he or she finishes using it, however, he or she may forget to turn off the printer. Therefore, the printer is using up power when the person has no intention of using it. This is a very common situation because many people have numerous appliances plugged into a power strip and it becomes easy to forget which appliances should be turned off when they are done being used.

Description of Apparatus

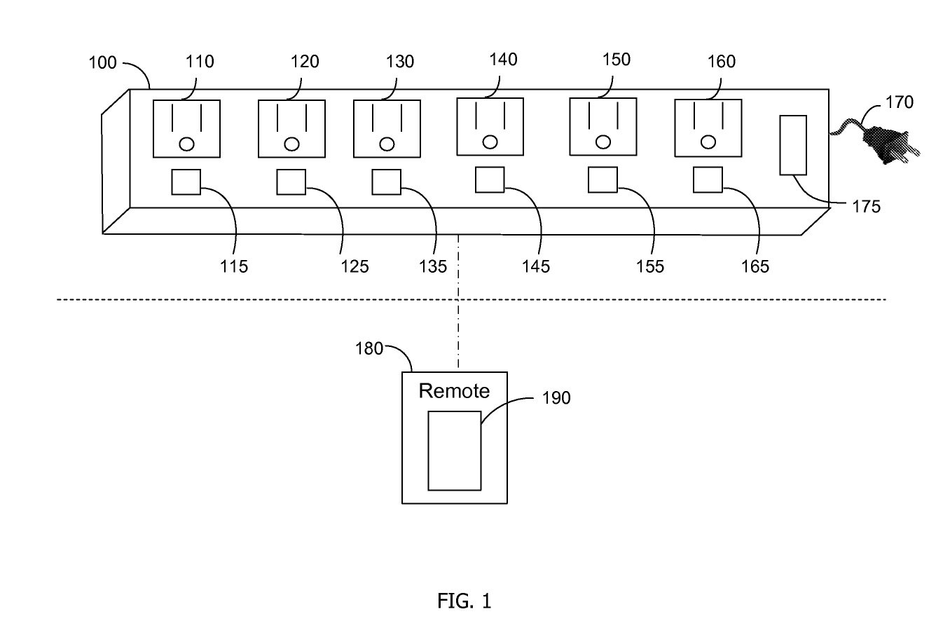

Referring now to FIG. 1, an exemplary view of a green power strip is shown. The green power strip may comprise a power strip 100 and a wireless remote control 180. While the following description primarily discusses an apparatus having one power strip, the described apparatus and method are applicable to configurations comprising multiple power strips and multiple remote controls. Further, while the following description primarily discusses an apparatus comprising a power strip, the described apparatus and method are not limited to power strips, but instead can also be used on surge protectors. Surge protectors contain components designed to reduce the surges and spikes that pass through electrical lines to your equipment. In addition, the described apparatus and method may also be used on other power appliances that are similar to power strips and surge protectors.

The power strip 100 may comprise a plurality of electrical outlets. The power strip can have anywhere from one electrical outlet to any number of electrical outlets. In FIG. 1, the power strip 100 comprises six electrical outlets. These electrical outlets can be seen as the components identified as 110, 120, 130, 140, 150 and 160. The power strip may be designed as one long strip of electrical outlets or alternatively it may comprise multiple rows of electrical outlets. Alternatively, the power strip may be designed as a series of individual outlets held together by a cable, or as an outlet receptacle and face plate (e.g., two outlets top/bottom or side to side).

The electrical outlets on the power strip allow various appliances and equipment to be plugged into the power strip 100. There is no restriction on which appliances may be plugged into the power strip and which appliances may not be plugged into the power strip. Therefore, appliances ranging from televisions, computers, scanners, printers, microwaves, and the like can all be plugged into the power strip.

The power strip 100 may comprise a master switch 175. The master switch may be used to turn the power strip on or off. The master switch may control whether all of the outlets are on or whether all of the outlets are off.

The power strip 100 may comprise a corresponding switch for each outlet on the power strip. In FIG. 1, the corresponding switch for the electrical outlet 110 is the switch labeled 115. Similarly, the corresponding switch for the electrical outlet 120 is the switch labeled 125. The corresponding switch for the electrical outlet 130 is the switch labeled 135. The corresponding switch for the electrical outlet 140 is the switch labeled 145. The corresponding switch for the electrical outlet 150 is the switch labeled 155 and the corresponding switch for the electrical outlet 160 is the switch labeled 165.

Alternatively, the power strip may be designed whereby one switch may control a certain group of electrical outlets on the power strip. That is, one switch on the power strip may control two or three outlets, while another switch may control the rest of the outlets.

The power strip 100 may also comprise a cable 170 to allow the power strip to be plugged into an outlet on a wall or even another power strip.

The power strip 100 may comprise an LED to identify when the power strip is on and when the power strip is off. In addition, the power strip 100 may comprise a screen display to visually show the user whether the power strip is on or off.

The power strip may also comprise a wireless remote control 180. The wireless remote control 180 may comprise a remote control switch 190. The remote control switch 190 may be used to control one or multiple electrical outlets on the power strip. The user may configure the power strip in such a manner that the outlets are individually controllable or instead are controllable as groups.

For example, the user may select a subset of outlets on the power strip that are to be controlled by the wireless remote control. For example, in FIG. 1, the user may select outlets 110 and 130 to be controlled by the wireless remote control. For outlets 110 and 130 to be controlled by the wireless remote control, the corresponding switches 115 and 135 will need to be put in a position that identifies that outlets 110 and 130 are to be controlled by the wireless remote control. Once these selected outlets are identified as being controlled by the wireless remote control, then when the remote control switch 190 is pressed, these outlets will turn the attached devices on or off.

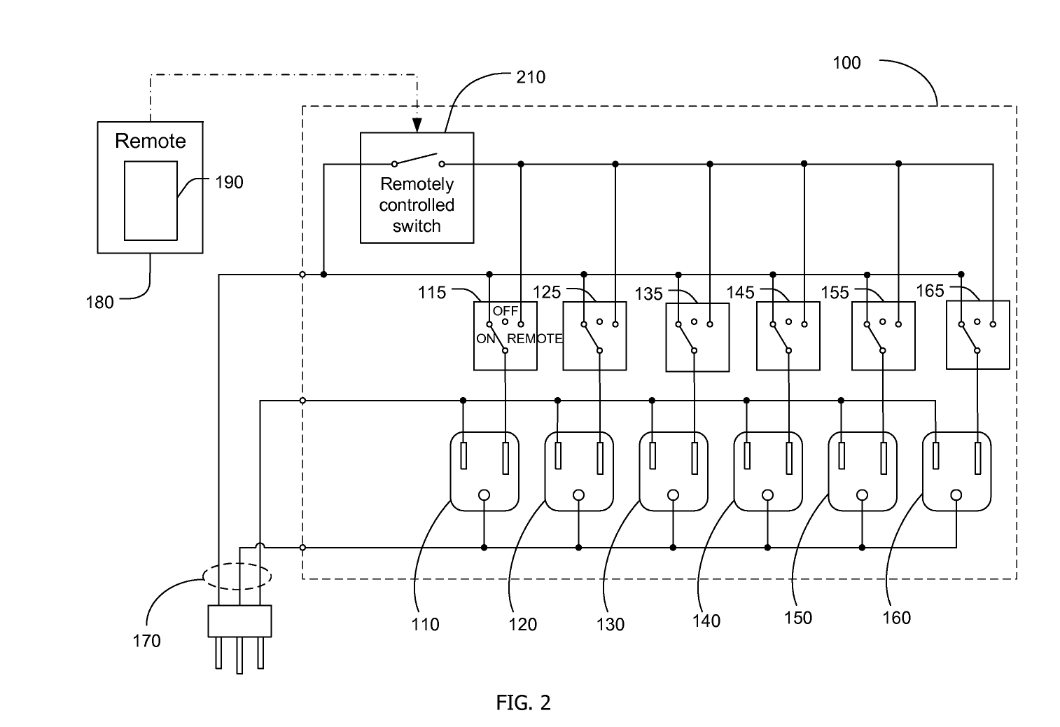

Referring to FIG. 2, a schematic view of the green power strip shown in FIG. 1 is shown. FIG. 2 illustrates that each of the switches 115-165 may be configured in three possible positions.

First, the switch may be configured to be in the ON position. When the switch is in the ON position, the corresponding outlet remains on at all times. For example, in FIG. 2, switch 115 can be placed in the ON position by pressing the switch and placing it in the left position.

Second, the switch may be configured to be in the OFF position. When the switch is in the OFF position, the corresponding outlet remains off at all times. For example, in FIG. 2, switch 115 can be placed in the OFF position by keeping the switch in a neutral position with neither side of the switch pressed down.

Third, the switch may be configured to be in the REMOTE position. When the switch is in the REMOTE position, the remotely controlled switch 210 allows for the corresponding outlet to be controlled by the wireless remote control. For example, in FIG. 2, switch 115 can be placed in the REMOTE position by pressing the switch and placing it in the right position.

For example, a person may plug a computer, a printer and a scanner into a power strip. The person may choose to program the remote control to control the outlets that the printer and scanner are plugged into. To do so, the person would put the corresponding switches for the printer and the scanner into the REMOTE position to identify that the printer and scanners are to be controlled by the wireless remote control. After putting the switch into the REMOTE position, the person can press the remote control switch 190 on the wireless remote control 180 and turn off the printer and scanner.

The wireless remote control 180 may also be used to control multiple power strips. For example, a person may have two power strips in which a printer and a scanner are all plugged into the first power strip and a laptop computer is plugged into a second power strip. The person may wish to turn off the laptop computer and the scanner after leaving home. To do this, the person can put the corresponding switches for the scanner (on the first power strip), and the laptop computer (on the second power strip) into the REMOTE position. After putting these switches in the REMOTE position, the person can press the remote control switch 190 on the wireless remote control 180 to turn off the scanner (on the first power strip) and the laptop computer (on the second power strip). Therefore, the corresponding switch for each of the outlets on the power strip can be used to select the corresponding outlet on the power strip.

Alternatively, the wireless remote control 180 may comprise a keypad and a display screen. The keypad and display screen may be used to enter in a code which identifies a certain power strip. In this setup and using the example described in the previous paragraph, the user would first enter in a code for the first power strip to turn on or off the scanner plugged into the first power strip, and then the user would enter in the code for the second power strip to turn on or off the laptop computer.

Alternatively, the person may have a wireless remote control for each power strip. In such a configuration, the person would have two wireless remote controls in the example described above. In other words, the person would use the first wireless remote control to control the scanner which is plugged into the first power strip and he or she would also have a second wireless remote control to control the laptop computer which is plugged into the second power strip.

The power strip 100 may be Bluetooth-compatible. Alternatively, the power strip may be compatible with Wi-Fi, or infrared technology.

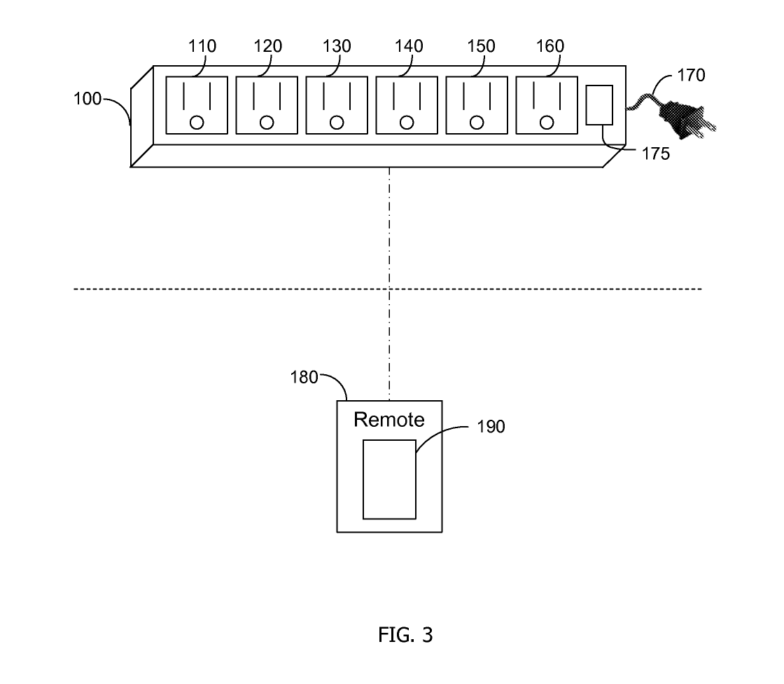

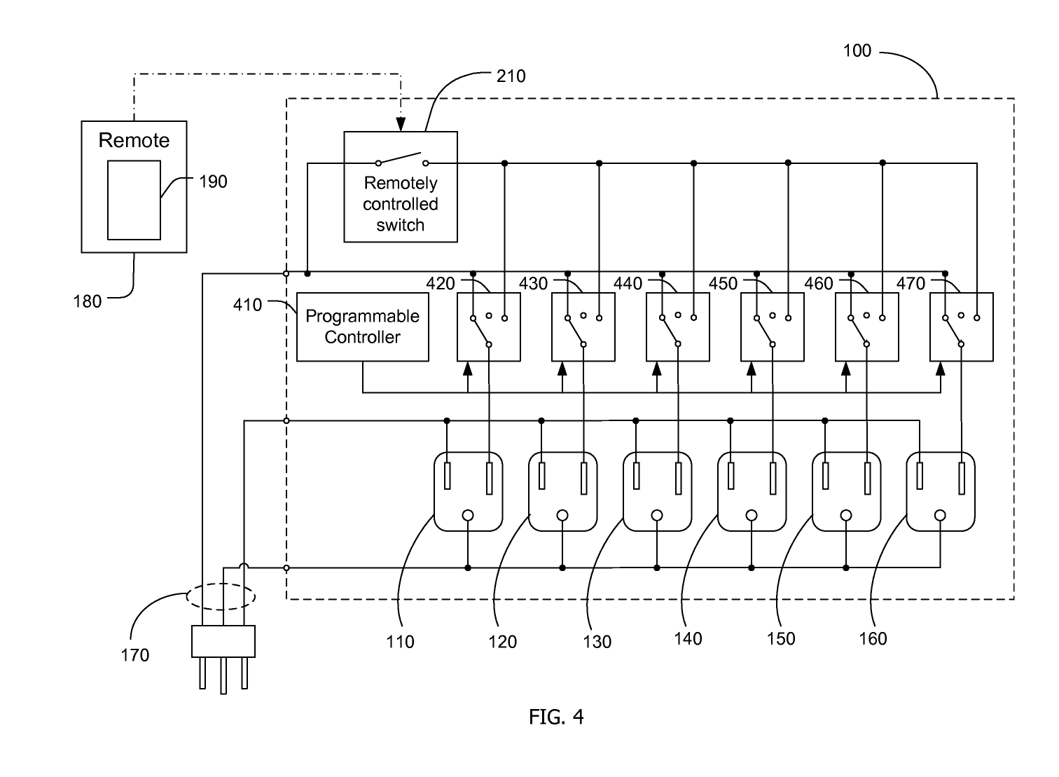

Referring to FIG. 3, an exemplary view of a green power strip is shown. In this example, the power strip 100 has six outlets identified as outlets 110, 120, 130, 140, 150 and 160. Each of the outlets has a corresponding solid state switch. These solid state switches are illustrated in FIG. 4 and are discussed further below. The power strip 100 may have a master switch 175 that controls whether the power strip is on or off.

Referring to FIG. 4, a schematic view of the green power strip shown in FIG. 3 is shown. In this example, each of the outlets 110-160 of the power strip 100 has a corresponding solid state switch. For example, outlet 110 has a corresponding solid state switch 420. The outlet 120 has a corresponding solid state switch 430. The outlet 130 has a corresponding solid state switch 440. The outlet 140 has a corresponding solid state switch 450. The outlet 150 has a corresponding solid state switch 460, and the outlet 160 has a corresponding solid state switch 470.

The power strip 100 also has a programmable controller 410. The programmable controller 410 determines the group of outlets that are selected and which are to be controlled by the wireless remote control. The programmable controller may be programmed using a computing device. A computing device as used herein refers to any device with a processor, memory and a storage device that may execute instructions including, but not limited to, personal computers, server computers, computing tablets, set top boxes, video game systems, personal video recorders, telephones, cell phones, personal digital assistants (PDAs), portable computers, and laptop computers. These computing devices may run an operating system, including, for example, variations of the Linux, Unix, MS-DOS, Microsoft Windows, Palm OS, Solaris, Symbian, and Apple Mac OS X operating systems.

Alternatively, the programmable controller may be programmed using the wireless remote control 180, or any other device. The programmable controller may also be programmed using dip switches or RF pairing.

The user may use a computing device, a wireless remote control, dip switches, or RF pairing to program the programmable controller. The programmable controller puts the corresponding solid state switches in the state that determines whether the corresponding outlets are controlled by the wireless remote control, or by the power strip itself. The programmable controller is used to select a subset of outlets that are to be controlled by the wireless remote control.

For example, the user may choose to select outlets 120 and 140 to be controlled by the wireless remote control. To do so, the user would program the programmable controller to select outlets 120 and 140. Once the programmable controller is programmed to determine the selected subset of outlets on the power strip, namely outlets 120 and 140 in this case, then the user can use the remote control switch 190 to turn off the devices attached to the corresponding outlets.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items, a “subset” of items, and the like may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. An apparatus comprising
a power strip comprising a plurality of outlets
a wireless remote control comprising a remote control switch
wherein a subset of the plurality of outlets on the power strip is selectable and
wherein the remote control switch controls the selected subset of the plurality of outlets.

2. The apparatus of claim 1 wherein
the power strip further comprises a corresponding switch for each of the plurality of outlets
wherein the subset of the plurality of outlets is selectable using the corresponding switch for each of the plurality of outlets.

3. The apparatus of claim 2 wherein the corresponding switch for each of the plurality of outlets can be set to at least an ON position or a REMOTE position
wherein the ON position of the corresponding switch indicates that the corresponding outlet of the plurality of outlets remains on at all times
wherein the REMOTE position of the corresponding switch indicates that the corresponding outlet of the plurality of outlets is controlled by the wireless remote control.

4. The apparatus of claim 3 wherein the corresponding switch for each of the plurality of outlets can be set to an OFF position
wherein the OFF position of the corresponding switch indicates that the corresponding outlet of the plurality of outlets remains off at all times.

5. The apparatus of claim 1 wherein
the power strip further comprises
a corresponding solid state switch for each of the plurality of outlets
a programmable controller to select the subset of the plurality of outlets.

6. The apparatus of claim 4 wherein the programmable controller is programmed using a computing device.

7. The apparatus of claim 4 wherein the programmable controller is programmed using the wireless remote control.

8. The apparatus of claim 1 further comprising
a second power strip comprising a plurality of second outlets
wherein a subset of the plurality of second outlets on the second power strip is selectable and
wherein the remote control switch controls the selected subset of the plurality of second outlets.

9. The apparatus of claim 8 wherein
the second power strip further comprises a corresponding switch for each of the plurality of second outlets
wherein the subset of the plurality of second outlets is selectable using the corresponding switch for each of the plurality of second outlets.

10. The apparatus of claim 9 wherein the corresponding switch for each of the plurality of second outlets can be set to at least an ON position or a REMOTE position
wherein the ON position of the corresponding switch indicates that the corresponding outlet of the plurality of second outlets remains on at all times
wherein the REMOTE position of the corresponding switch indicates that the corresponding outlet of the plurality of second outlets is controlled by the wireless remote control.

11. The apparatus of claim 10 wherein the corresponding switch for each of the plurality of second outlets can be set to an OFF position
wherein the OFF position of the corresponding switch indicates that the corresponding outlet of the plurality of second outlets remains off at all times.

12. The apparatus of claim 1 further comprising
a plurality of power strips
wherein each of the plurality of power strips comprises a plurality of outlets
wherein a subset of the plurality of outlets on each of the plurality of power strips is selectable and
wherein the remote control switch controls the selected subset of the plurality of outlets on each of the plurality of power strips.
